(19) United States
(12) Patent Application Publication
(10) Pub. No.: US 2009/0256647 A1
(43) Pub. Date: Oct. 15, 2009

(54) Band Blocking Filter for Attenuating Unwanted Frequency Components

(76) Inventor: Thomas V. Bruhns, Mukilteo, WA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 12/101,078

(22) Filed: Apr. 10, 2008

(51) Int. Cl. H01P 5/18

(52) U.S. Cl. 333/109; 327/551

(57) ABSTRACT

A band-blocking filter for attenuating an unwanted frequency component in a signal having a plurality of frequency components is disclosed. The band-blocking filter includes an input port, a cancellation signal generator, and a combining circuit. An input signal having the plurality of frequency components including a first frequency component at a frequency of f_{b} characterized by an amplitude, A, and phase and a second frequency component having a frequency of f_{g} is received on the input port. The cancellation signal generator generates a cancellation signal having a frequency of f_{b} and an amplitude and phase determined by the first frequency component that is applied to a combining circuit that combines the cancellation signal with the input signal to generate an output signal that includes the second frequency component and a residual signal at frequency f_{b} having an amplitude less than A.

### BACKGROUND OF THE INVENTION

Multiple signals are often transmitted over a common communication link by some form of frequency division multiplexing in which each signal is used to modulate a carrier having a different carrier frequency. The modulated carriers are then sent together over the communication link. A user wishing to receive a particular signal separates the desired signal from the combined signal in a receiver in which the combined signal is mixed with a local oscillator (LO) signal having a frequency near that of the carrier of the desired signal. The output of the mixer is then filtered to recover the signal of interest.

Conventional radio broadcasts are examples of this transmission scheme. Each station broadcasts on a different RF carrier frequency by modulating a signal at that frequency which is then transmitted via an antenna into the region serviced by that station. A receiver placed in the region receives the combined signals from all of the radio stations within range. The receiver selects a particular station by mixing the received signal with an LO signal having a frequency near that of the desired station. The output of the mixer is then filtered to provide an intermediate frequency (IF) signal that can be analyzed by subsequent electronics to provide the original modulation signal.

Ideally, the mixer converts each frequency, f_{RF}, in the input RF signal band to two signals at frequencies f_{RF}±f_{LO}, where f_{LO} is the frequency of the LO signal. An IF filter that passes signals in a narrow band of frequencies eliminates the signals at f_{RF}+f_{LO} and the IF signal at f_{RF}−f_{LO} for which f_{RF} is outside the region of interest. Hence, the IF signal is a single carrier modulated with the signal of interest in which the carrier is at a frequency that can be easily processed by the subsequent electronics.

Unfortunately, mixers are not ideal. As a result, the output of the mixer includes signals at additional frequencies. Commercially available mixers are non-linear, and hence, additional signals at harmonics of the RF and LO signals are generated. These harmonics are mixed together by the mixer to generate additional output signals at the sums and differences of various harmonics of the RF and LO frequencies. Hence, the output of the mixer includes components at frequencies mf_{RF}±nf_{LO}, where m and n are integers, for each frequency in the input RF signal. The components at frequencies corresponding to m and n different from 1 are referred to as intermodulation distortion products. If one of the distortion products corresponding to a carrier that is different from the carrier of interest is within the pass band of the IF filter, that carrier can interfere with the detection of the carrier of interest. If the interfering signal and the signal of interest have the same signal strength, the interference is usually insufficient to interfere with the detection of the signal of interest, since the amplitudes of the distortion products are typically significantly less than those of the desired mixer products. However, if the signal of interest has an amplitude that is significantly less than that of one of the signals giving rise to the distortion product, the distortion product can interfere with the detection of the signal of interest.

Ideally, a receiver that does not add distortion products to the spectrum of interest would be utilized in those cases in which a strong interfering signal prevents the reception of the signal of interest. Unfortunately, even the best of the currently available receiving equipment generates distortion products that interfere with reception of small signals in the presence of large ones. This problem is particularly severe in the region of the broadcast spectrum from about 30 kHz to 39 MHz; however, this problem also occurs in other frequency bands. Furthermore, the degree of interference depends on the relative strength of the signals, and hence, there will often be situations in which a very small signal cannot be separated in an environment having strong signals at other frequencies.

It should be noted that there are other situations in addition to the superhetrodyne receiver discussed above in which a large signal in the input signal can cause problems in detecting a small signal of interest. For example, there are receivers in which the entire spectrum of interest is digitized and processed digitally to select the signal of interest. Such receivers also suffer from distortion products in which signals at frequencies of n*f1±m*f2 are generated. Here, f1 and f2 are each a frequency contained in the signal path in the receiver. If the amplitude of one of these signals is sufficiently high, the distortion products may obscure a small signal of interest.

Furthermore, conventional superhetrodyne receivers can also suffer from an effect referred to as “desensitization”. Here, a large signal at one frequency can reduce the sensitivity of the receiver to a small signal at another frequency without introducing new frequency components that overlap the small signal of interest.

One method for reducing the interference utilizes some form of filter ahead of the mixer. The filter attenuates the interfering signals while passing the signal of interest. Ideally, the filter is a passive filter that does not introduce a significant amount of distortion into the signal of interest. This solution works well if the signal to be received and any large potential interfering signals are separated sufficiently in frequency and the signals that are removed by the filter are also not of interest. However, this solution does not work well when the application requires the receiver to simultaneously receive all the signals in a large segment of the spectrum. In addition, this solution does not work well when the large signals are close in frequency to the small signals of interest.

In another prior art method, a passive “notch” filter is used to attenuate the frequencies of known large signals while selectively passing the signal of interest. Unfortunately, practical passive filters cannot be tuned quickly to new frequencies as new large signals appear in the input spectrum. In addition, such filters generally remove more of the spectrum than is desired, potentially attenuating desired small signals at the same time as the large one is attenuated. In principle, electronically tuned filters can overcome some of these problems; however, electronically tuned filters that do not add distortion to the signal of interest are difficult to design.

### SUMMARY OF THE INVENTION

The present invention includes a band-blocking filter for attenuating an unwanted frequency component in a signal having a plurality of frequency components. The band-blocking filter includes an input port, a cancellation signal generator, and a combining circuit. The input port receives an input signal having the plurality of frequency components including a first frequency component at a frequency of f_{b} characterized by an amplitude, A, and phase and a second frequency component having a frequency of f_{g}. The cancellation signal generator generates a cancellation signal having a frequency of f_{b} and an amplitude and phase determined by the first frequency component. The combining circuit has a signal input that receives the input signal and a cancellation signal input that receives the cancellation signal. The combining circuit combines the cancellation signal with the input signal to generate an output signal on a combining circuit output line. The output signal includes the second frequency component and a residual signal at frequency f_{b} having an amplitude less than A. In one embodiment, the cancellation signal generator includes a band pass filter having a filter input and having a pass band that includes f_{b}. In another embodiment, the pass band has a center determined by a signal input to the band pass filter.

### BRIEF DESCRIPTION OF THE DRAWINGS

FIG. 1 illustrates the general principle used to make a signal filter according to one embodiment of the present invention.

FIG. 2 illustrates one embodiment of tunable band pass filter that could be utilized to implement the filter shown in FIG. 1.

FIG. 3 illustrates another embodiment of a band blocking filter according to the present invention.

FIG. 4 illustrates a hybrid filter according to another embodiment of the present invention.

FIG. 5 illustrates a band-blocking filter according to another embodiment of the present invention.

FIG. 6 illustrates a band-blocking filter according to another embodiment of the present invention.

FIG. 7 is a schematic drawing of a hybrid coil that could be utilized in the present invention.

### DETAILED DESCRIPTION OF THE PREFERRED EMBODIMENTS OF THE INVENTION

The present invention can be viewed as a tunable attenuation filter that attenuates an interfering signal without significantly distorting or attenuating other signals outside the filter band. Denote frequency of the interfering signal by f_{b} and frequency of a signal of interest by f_{g}. It should be noted that there might be a number of signals of interest at different frequencies that are different from f_{b}; however, to simplify the following discussion, a single signal of interest will be utilized. In one embodiment of the present invention, the filter operates by generating a signal having the same amplitude and phase as f_{b} and then subtracting that cancellation signal from the combined signal having components at f_{b} and f_{g} to generate a signal in which amplitude of the component at f_{b} is significantly reduced.

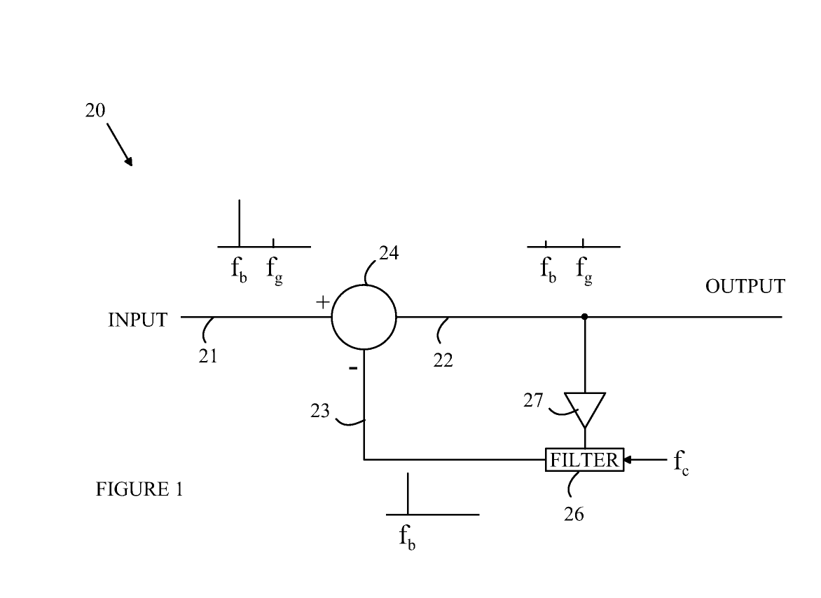

Refer now to FIG. 1, which illustrates the general principle used to make a signal filter according to one embodiment of the present invention. An input signal on line 21 having frequency components at f_{b} and f_{g} is input to a subtracting circuit 24 that subtracts the signal on line 23 from that on input line 21 to generate an output signal on line 22. A portion of the output signal is amplified by amplifier 27 and filtered through a tunable band-pass filter 26 that transmits signals in a narrow frequency band centered at f_{c}.

Consider the case in which f_{c}=f_{b}. Denote the gain of the combination of amplifier 27 and filter 26 for frequencies in the pass band of filter 26 by K, the amplitude of the signal at f_{b} on line 21 by A_{b}, and the amplitude of the signal at f_{b} on line 22 as A′_{b}. The amplitude of the signal leaving filter 26 within the pass band is KA′_{b}. Hence, the circuit will be in equilibrium when

A′_{b}=A_{b}/(K+1). (1)

Accordingly, the amplitude of the unwanted signal is reduced by a factor of (K+1). By setting the value of K sufficiently high, the unwanted signal amplitude can be reduced to an acceptable value. Ideally, A_{g} is not attenuated by filter 20. However, in practice, some attenuation can result from circuit 24. As long as filter 20 attenuates the signal at f_{b} by significantly more than filter 20 attenuates the signal at f_{g}, an improvement is obtained. In one embodiment of the present invention, A′_{b}/A_{b} is at most 0.01 times A′_{g}/A_{g}, where A′_{g} and A_{g} are the amplitudes of the signal at f_{g} on lines 21 and 22, respectively.

In practice, if A_{b} increases, then A′_{b} initially increases and the feedback signal on line 23 increases until Eq(1) is once again satisfied. Similarly, if A_{b} decreases, A′_{b} will likewise decrease, since the feedback signal will initially be too large. However, the reduced A′_{b} value leads to a reduced feedback signal amplitude, and hence, A′_{b} will return to the value given by Eq. (1). To prevent oscillations in the amplitude of the unwanted frequency component during the period in which the cancellation signal is varying in amplitude while seeking the equilibrium shown in Eq. (1), filter 26 can be designed to have a time response that is tailored to avoid such oscillations. That is, if the input to filter 26 at f_{c} experiences a rapid increase, the output amplitude of the cancellation signal from filter 26 on line 23 will increase gradually over the rise time to the new amplitude. The rise time is chosen such that the amplitude of the unwanted frequency component on line 22 does not oscillate.

It should also be noted that filter 26 can be designed to maintain a fixed phase relationship between the input signal and the output of filter 26. The phase is adjusted such that the output of filter 26 on line 23 is in phase with the component of the input signal on line 21 that is to be canceled. The manner in which this is accomplished will be discussed in more detail below.

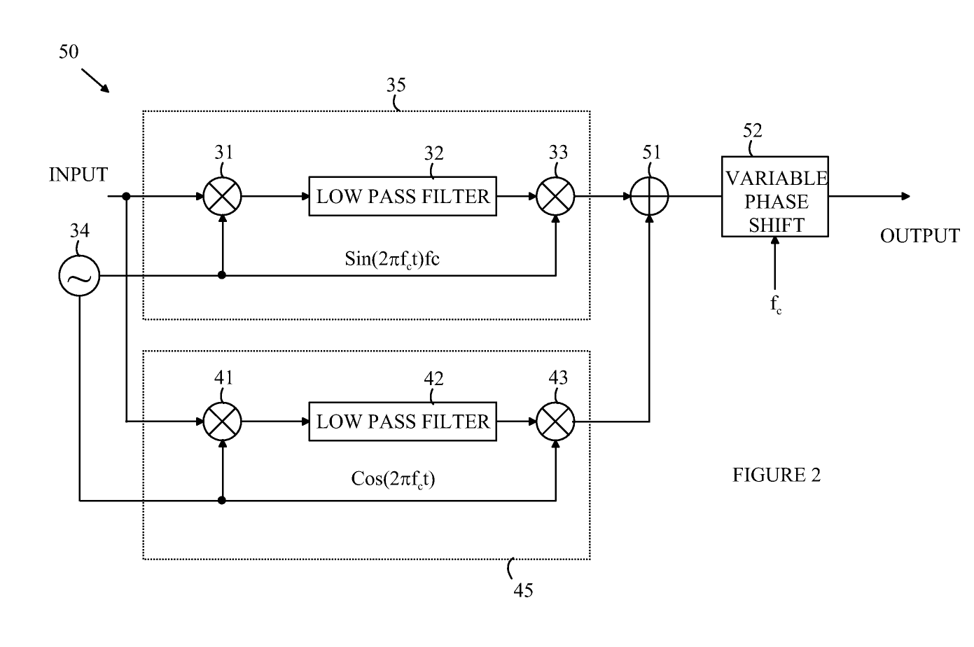

Refer now to FIG. 2, which illustrates one embodiment of tunable band pass filter that could be utilized to implement the filter shown in FIG. 1. Band pass filter 50 has a pass band centered at f_{c} with a width and shape determined by the shape of the pass band of low pass filters 32 and 42. Band pass filter 50 utilizes two sections, shown at 35 and 45, that filter the in phase and quadrature components of the input signal, respectively. Each section operates by mixing the input signal with a corresponding signal at f_{c} from generator 34 to down convert the components of the input signal at f_{c} to base band. The mixers for down converting the in-phase components and quadrature components are shown at 31 and 41, respectively. Each down converted signal is then filtered through a corresponding low pass filter that eliminates any frequency components outside of a band of frequencies that will eventually be up converted to a band around f,. The low pass filters corresponding to the in phase and quadrature components are shown at 32 and 42, respectively. The outputs of low pass filters 32 and 42 are then up converted by mixers 33 and 43, respectively, to return the filtered portion of the input signal to the original frequency band. Finally, the outputs of mixers 33 and 43 are combined in adder 51 to provide the output signal.

Ideally, the mixers utilized in band pass filter 50 are identical to one another. Similarly, the low pass filters are ideally identical to one another. It should be noted that the low pass filters inherently have a finite rise time that can be adjusted by adjusting the shape of the filter pass band. Hence, this type of band pass filter is particularly useful in constructing band-blocking filters such as band blocking filter 20 discussed above.

As noted above, the input and output signals should be in phase with one another. Hence, low-pass filters 32 and 42 are constructed such that any phase shift introduced by these filters and mixers 31 and 33 are a multiple of 360 degrees. In this regard, it should be noted that any phase shift introduced by the low pass filters is independent of the center frequency, f_{c}, and hence, the desired phase relationship can be built into the low pass filters provided the mixers do not introduce an additional phase shift that is a function of f_{c}. If the phase shift introduced by the mixers depends on f_{c}, a variable phase shift circuit 52 that introduces a phase shift that is a function of f_{c} can be incorporated to assure that input and output have the correct phase relationship.

The mixers 31, 33, 41, and 43 can introduce distortion products into the output of band pass filter 50. Such products can lead to unwanted signals on line 22 shown in FIG. 1. Any distortion products generated by mixers 31 and 41 that are outside of the pass band of the low pass filters will be eliminated by the low pass filters. Hence, any distortion products generated by mixers 31 and 41 will be limited to frequencies within the pass band of filter 50. Distortion products generated by mixers 33 and 43 will not be so limited; however, these distortion products are usually at frequencies that are relatively benign.

The above-described embodiments of the present invention utilize a feedback scheme that adjusts the residual amplitude of the component at f_{b} to a predetermined level at the output of the subtraction circuit. These embodiments require only one band pass filter and a high gain amplifier to implement. However, the required amplification levels needed to remove a large unwanted signal could be quite high. As noted above, the high amplification levels can lead to instabilities in the feedback loop if the band pass filter does not provide sufficient dampening. In addition, the amplification stage must be able to generate an output signal that has the same amplitude as the amplitude of the largest unwanted frequency component. Finally, if there is noise on line 22 that is not also on line 21 and that noise is in the frequency range around f_{c}, the feedback loop may not function properly.

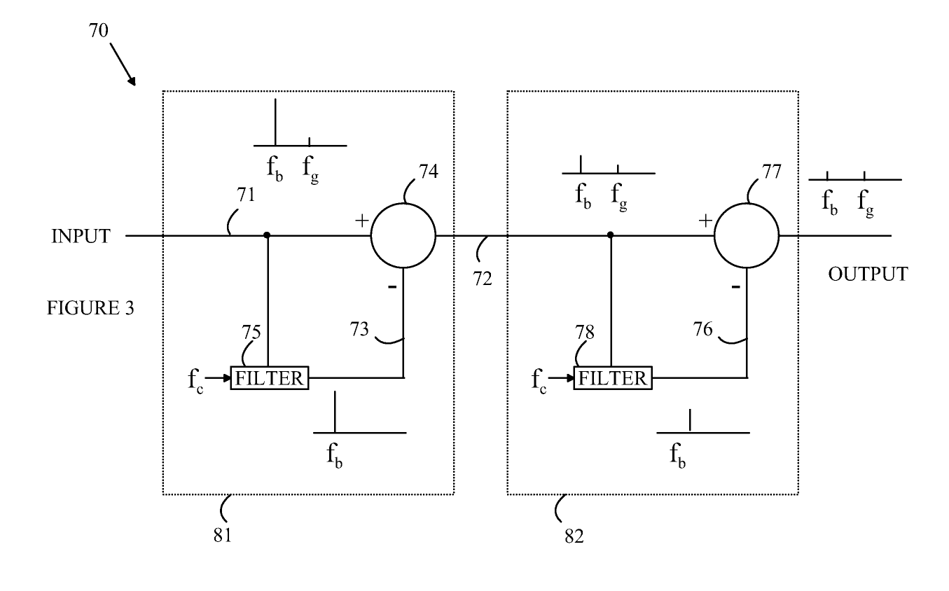

Refer now to FIG. 3, which illustrates another embodiment of a band-blocking filter according to the present invention. Band blocking filter 70 is a multi-stage filter that processes a signal on line 71. To simplify the drawing only two stages are shown, i.e., stages 81 and 82; however, it is to be understood that additional stages could be added if necessary. Furthermore, in some applications, a single stage could be utilized. Refer first to stage 81 that includes a band pass filter 75 that operates in a manner analogous to the band pass filters discussed above with reference to FIG. 2. That is, filter 75 passes signals centered in a frequency band about f_{c}. To simplify the present discussion, it will be assumed that filter 75 has a gain, K, that is slightly less than 1. If the gain of a particular filter does not satisfy this criterion, an amplifier or attenuator can be placed in series with the filter input. In practice, if the gain is within some reasonably small δ from unity, the system will work, and the output will be −δ*Aᵢₙ. To the degree that the magnitude of δ is smaller than unity, the amplitude of the output will be lower than the amplitude of the input. It should be noted that this system also works for cases where there the phase shift through the filter is not zero.

Consider the case in which f_{c}=f_{b}. Filter 75 will have an output whose amplitude is slightly less than the amplitude of the unwanted signal component at f_{b}. Accordingly, the output of subtractor 74 at f_{b} on line 72 will be reduced by a factor 1/(1−K). It should be noted that no feedback loop is needed to provide this reduction. Second stage 82 will likewise reduce the amplitude of the component at f_{c}=f_{b} by another factor of (1−K), and hence, the amplitude of the unwanted frequency component at the output of subtractor 77 will be reduced by a factor 1/(1−K)². Thus, by providing the appropriate number of stages, the unwanted frequency component can be reduced to the desired level without the need to provide a band pass filter that has the dampening characteristics discussed above.

The problems associated above with respect to providing a high gain amplifier that has a maximum output equal to the maximum amplitude of the unwanted component that is expected to be encountered are also substantially reduced. If the output of filter 75 is limited such that the signal on line 73 is less than K times the amplitude of the unwanted component, where K is substantially less than 1, the unwanted component at the output of subtractor 74 will still have a reduced amplitude compared to the amplitude of that component at the input of subtractor 74. That is, a limitation introduced by filter 75, or a component such as an internal amplifier, merely lowers the value of K. However, compensation for lower K values can be achieved by using more stages.

The cascaded stage arrangement shown in FIG. 3 can also reduce some of the distortion products introduced by the filters. As noted above, non-linearity in the mixers used to construct the band pass filters can lead to some distortion products at frequencies near f_{b} being introduced into the signal path carrying the desired signals. The amplitudes of these distortion products are related to the amplitude of the signal entering the band pass filter, the smaller the amplitude of the signal at f_{b}, the smaller the amplitude of the distortion products. In general, the magnitude of the distortion products decreases in a non-linear manner with respect to the amplitude of the signals being mixed, and hence, reducing the amplitude of the signal at f_{b} by half will result in the amplitude of the distortion products being reduced by more than a factor of two. Since the amplitude of the unwanted signal entering stage 82 is significantly reduced compared to the amplitude of that signal when that signal entered stage 81, the additional distortion products generated in the second stage will, in general, be much less, and hence, less of a problem.

Consider the distortion products generated in the first stage that form part of the input to the second stage and which are within the pass band of filter 75. If the pass band of band pass filter 78 is at least as broad as that of band pass filter 75, these frequency components will pass through filter 78 and be subtracted from the combined input of subtractor 77. If the pass band of filter 78 were the same for all frequencies within the band, the amplitude of the distortion products and the amplitude of the unwanted component at f_{b} would be reduced by the same factor since the distortion products would generate cancellation signals on line 76 in the same manner as the unwanted frequency component at f_{b}. In practice, the percentage of the signals passed by filter 78 will, in general, decrease with the frequency difference from the center of the pass band, and hence, the distortion products are not expected to be removed to the same extent as the signal at f_{b}. However, a substantial improvement could still be realized.

In the above-described embodiment, the band pass of filter 75 was assumed to be the same as that of filter 78. However, embodiments in which the pass bands of the filters are substantially different can also be constructed to provide advantages in some situations. As noted above, filter 75 can introduce distortion products that are outside of the pass band of filter 75 because the final mixers in the filters are non-linear. If filter 78 has a pass band that includes these distortion products, then stage 82 will reduce the distortion products introduced by stage 81. In many cases, the distortion products that cause significant problems will be located at frequencies that are between f_{b} and f_{g} but outside the pass band of filter 75. Hence, if the pass band of filter 78 is increased relative to that of filter 75, a significant reduction in the distortion products can be realized. The maximum width of the pass band for filter 78 is determined by the difference in frequency between f_{b} and f_{g}, since the pass band of filter 78 must not include f_{g}.

Multi-stage filters that utilize the embodiments discussed above with reference to FIG. 1 can also be constructed with similar benefits. In particular, the gain of the amplifier 27 in each stage can be reduced since the reduction in signal amplitude needed in each stage is less. Reducing the amplification gain reduces the amount of dampening needed to control oscillation. In addition, the second stage can be constructed such that some of the distortion products introduced by the first stage are attenuated in a manner analogous to that discussed above. Finally, the maximum output of the amplifiers needed to remove the unwanted frequency component is significantly reduced.

The above-described embodiments utilize analog band pass filters. Implementing analog filters with particular pass band shapes that are reproducible from filter to filter can pose challenges in some filter designs. In this regard, it should be noted that the low pass filters and mixers shown in FIG. 2 are ideally identical to one another. For example, if the filters are implemented with analog components, the variations in the impedances of those components from component to component can introduce significant differences in the pass band of filter 32 with respect to the pass band of filter 42.

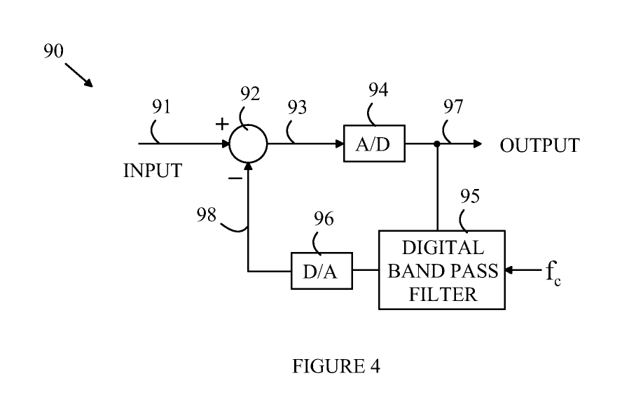

The problems associated with the analog implementation of the band pass filters can be reduced by utilizing a digital implementation of the band pass filter in applications in which the frequencies in the mixed signal being processed are within the frequency range of available digital components. Refer now to FIG. 4, which illustrates a hybrid filter according to another embodiment of the present invention. Filter 90 operates by subtracting an analog cancellation signal on line 98 from an analog input signal on line 91 to reduce the amplitude of a frequency component of the input signal having a frequency in a band of frequencies centered at f_{c}. The output of subtractor circuit 92 on line 93 is digitized by an analog-to-digital converter 94 to provide a digital output signal on line 97. The digital output signal is filtered through a digital band pass filter 95 having a pass band centered at f_{c} to generate a digital cancellation signal that is converted back to an analog signal by digital-to-analog converter 96. It should be noted that A/D converters generally have a “hard” upper limit on the amplitude of signal that can be digitized. That is, there is a maximum value to the digital word at their output, corresponding to some amplitude of analog input signal. If f_{b} is chosen as the largest amplitude signal of all the signals at the input line 91, a very significant reduction in the maximum amplitude of signal remaining on line 93 can be achieved, allowing use of an A/D with reduced maximum analog input level.

Refer again to FIG. 1. The above-described embodiments utilize an arrangement in which the band pass filter is connected directly to the input or output lines of the subtractor circuit. This arrangement assumes that there are no signals propagating from the output to the input that can be mistaken by the band pass filter for a signal at f_{b} that has survived the cancellation in subtractor 24. For example, an impedance mismatch after subtractor 24 could cause a reflection of the signal at f_{b} at a point after the output of filter 20. The reflected signal would travel backward toward subtractor 24. This signal would be amplified and sent to subtractor 24 on line 23. In general, this signal will be out of phase with the component signal at f_{b} on line 21. This signal will also have an amplitude that could alter the stability of the feedback loop. To prevent these problems, a unidirectional coupler can be incorporated in the filter design.

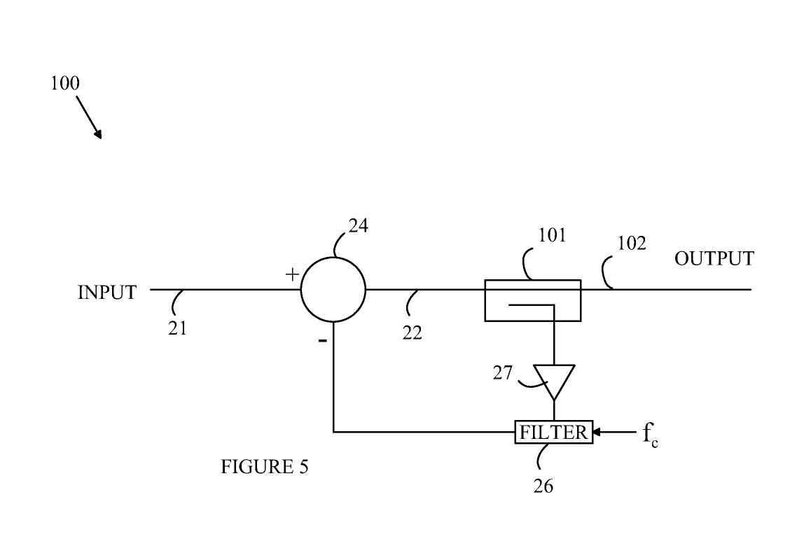

Refer now to FIG. 5, which illustrates a band-blocking filter according to another embodiment of the present invention. Band-blocking filter 100 is similar to band blocking filter 20 shown in FIG. 1 in that a feedback loop is used to generate a cancellation signal that is applied to subtractor circuit 24 to cancel an unwanted component in the input signal on line at a frequency of f_{c}. The cancellation signal is derived from the signal on the output line 22 by coupling a portion of that signal to amplifier 27 via a unidirectional coupler 101 that prevents signals propagating from line 102 to line 22 from being amplified by amplifier 27.

The above-described embodiments of the present invention utilize a subtractor circuit that subtracts the cancellation signal from the input signal to remove the unwanted frequency component. However, any circuit that combines the two signals in a manner that attenuates the amplitude of the unwanted frequency component relative to that of the desired component could be utilized. For example, an adder that has a 180 degree phase shift circuit connected to the cancellation signal input could be utilized. It should also be noted that the phase shift could be included in the filter. That is, the low pass filter could introduce a phase shift to the signal passing the filter such that the output of the band pass filter is 180 degrees out of phase with the input to the band pass filter. In addition, the combining circuit in question ideally terminates the input lines to the circuit to prevent signals from being reflected back into those input lines, and the output line terminates any signals propagating back into the output.

In one embodiment of the present invention, the combining circuit is constructed from a hybrid coil. For the purposes of this discussion, a hybrid coil is defined to be a single transformer having effectively four windings interconnected in a particular way, which is designed to be connected to four branches of a circuit so as to render these branches conjugate pairs. Such coils can also be utilized to construct the directional coupler discussed above. In these embodiments of the present invention, one of the four ports is terminated and the remaining three ports are utilized. Denote the terminated port by D and the remaining 3 ports by A, B, and C, respectively.

Consider an embodiment in which a 20 dB directional coupler is utilized. Power entering port A goes to ports B and C in a particular ratio. In this case, 99 percent of the power leaves port B, and 1 percent leaves port C; hence the name “20 dB directional coupler”. No power, however, is fed to port D (the internally terminated port). For an input signal into port C, 1 percent of the power goes out port A, and 99 percent goes to the internal termination at port D. None of the port C input goes to port B. Finally, an input signal to port B splits between port D and port A with 99 percent going to A and 1 percent going to D. It should be noted that this type of coupler is a passive device, and may be constructed such that it does not introduce significant distortion products into the signals. Second, ports B and C never directly couple power to each other in either direction, and the coupling between A and C is 1/100 either direction.

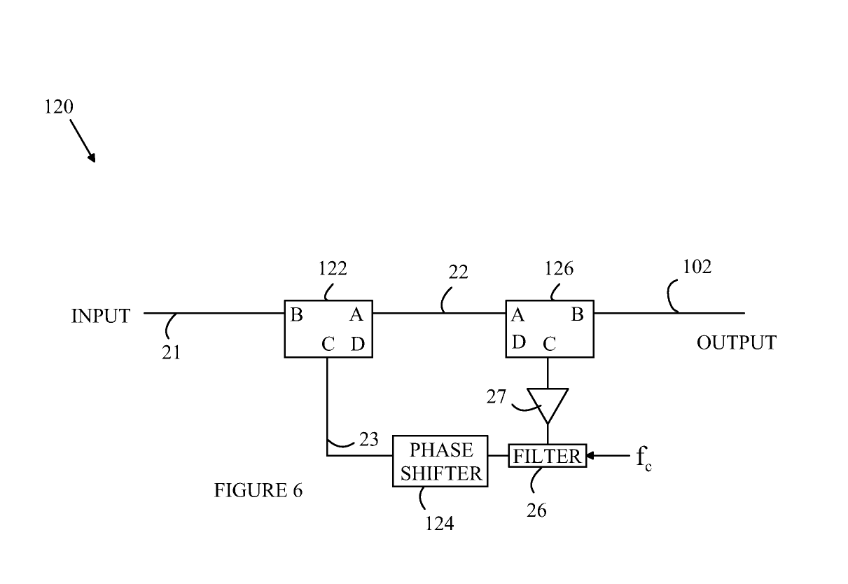

Refer now to FIG. 6, which illustrates an embodiment of a band-blocking filter according to another embodiment of the present invention. Band blocking filter 120 is similar to band-blocking filter 100 shown in FIG. 5. However, in band-blocking filter 120, a directional coupler 122 of the type discussed above and a 180 degree phase shifter 124 are used to implement circuit 24. Similarly, a directional coupler 126 of the type used above is used to implement directional coupler 101 shown in FIG. 5. The ports of directional couplers 122 and 126 have been labeled in accordance with the labels used in the above discussion.

As noted above, inputs B and C of directional couplers 122 and 126 do not couple energy between each other. Hence, the cancellation signal generated on line 23 is not coupled back to input line 21. This prevents the cancellation signal from being coupled to the input and any circuit connected to that input. Similarly, any signal input on line 102 is not coupled to the input of amplifier 27.

At port A in directional coupler 122, the signals from ports B and C are added together. Since phase shift circuit 124 has introduced a 180 degree phase shift into the output of filter 26, the output of port A is the amplitude of the signal on line 21 minus the amplitude of signal at the output of filter 26 multiplied by a factor that depends on the splitting ratio of directional coupler 122. In the case of the 20 dB directional coupler discussed above, the factor in question is 1/100. However, it should be noted that the feedback loop will compensate for this factor provided the amplification factor of amplifier 27 is sufficiently high.

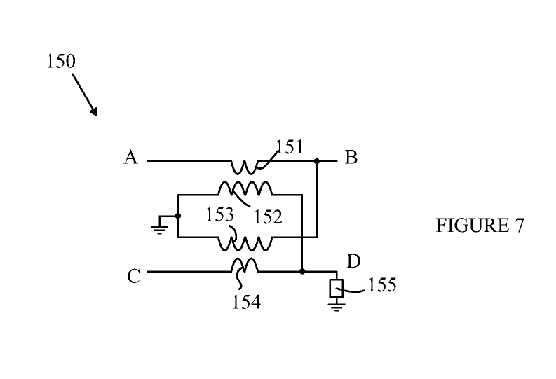

Directional couplers of the type discussed above are known to the art, and hence, will not be discussed in detail here. Refer to FIG. 7, which is schematic drawing of a transformer based directional coupler. For the purposes of the present discussion, it is sufficient to note that directional coupler 150 includes four coils 151-154. Coils 151 and 154 have the same number of turns. The coupling factor discussed above is determined by the ratio of the turns of coil 152 to coil 151 or coil 153 to coil 154. For example, in a 20 dB coupler, coils 152 and 153 each has 10 times the number of turns as coils 151 and 154. Coils 151 and 152 are tightly coupled magnetically, as are coils 153 and 154. There is assumed to be no magnetic coupling between coil sets (151, 152) and (153,154). Output D is terminated by an impedance element 155.

While the above-described embodiments utilize hybrid coil directional couplers, other forms of directional couplers can also be utilized. For example, a hybrid junction coupler could also be utilized. For the purposes of this discussion, a hybrid junction is defined to be a waveguide or transmission-line arrangement with four ports which, when the ports have reflectionless terminations, has the property that energy entering at one port is transferred to two of the remaining three ports in a particular constant ratio.

The above-described embodiments utilize a low-pass filter to filter the down converted signal. However, other band-pass filter or filters could also be utilized with an appropriate adjustment of the LO signal frequency.

Refer again to FIGS. 1 and 2. In the embodiment shown in FIG. 1, a separate amplifier is shown at the input to filter 26. However, it is to be understood that this amplifier could be part of filter 26 or distributed along the feedback loop. For example, the embodiment of the bandpass filter shown in FIG. 2 could be modified to include amplification stages as part of the low pass filters 32 and 42. In addition, an amplification stage could be included in the subtractor circuit 24 shown in FIG. 1. Accordingly, it is to be understood that amplifier 27 could be a distributed amplifier with gain components in filter 26 and/or subtractor 24 instead of, or in addition to, the discrete amplifier 27 shown in FIG. 1.

Various modifications to the present invention will become apparent to those skilled in the art from the foregoing description and accompanying drawings. Accordingly, the present invention is to be limited solely by the scope of the following claims.

What is claimed is:

1. An apparatus comprising:
an input port that receives an input signal having a plurality of frequency components including a first frequency component at a frequency of f_{b} characterized by an amplitude, A, and a second frequency component having a frequency of f_{g} that is different from f_{b}.
a cancellation signal generator that generates a cancellation signal having a frequency of f_{b} and an amplitude and phase determined by said first frequency component; and
a combining circuit having a signal input that receives said input signal and a cancellation signal input that receives said cancellation signal, said combining circuit combining said cancellation signal with said input signal to generate an output signal on a combining circuit output line, said output signal having said second frequency component and a residual signal at frequency f_{b} having an amplitude less than A.

2. The apparatus of claim 1 wherein said combining circuit comprises a directional coupler.

3. The apparatus of claim 1 wherein said directional coupler comprises a hybrid coil or hybrid junction.

4. The apparatus of claim 1 wherein said cancellation signal generator comprises a band pass filter having a filter input and having a pass band that includes f_{b}.

5. The apparatus of claim 4 wherein said filter input is connected to said combining circuit signal input.

6. The apparatus of claim 4 wherein said filter input is connected to said combining circuit output line.

7. The apparatus of claim 6 wherein said filter input is connected to said combining circuit output line through a unidirectional coupler that blocks signals traveling toward said combining circuit output line from entering said filter.

8. The apparatus of claim 6 wherein said band pass filter further comprises an amplifier that amplifies signals received on said filter input.

9. The apparatus of claim 4 wherein said pass band has a center determined by a signal input to said band pass filter.

10. The apparatus of claim 1 wherein said cancellation signal generator comprises:
a first mixer that mixes a cancellation circuit input signal with a first LO signal having a frequency determined by f_{b} to generate a first mixer output signal;
a first low-pass filter that filters said first mixer output signal to generate a first low-pass filter output signal in which frequency components of said mixer output signal having frequencies above a first cutoff frequency are substantially attenuated; and
a second mixer that mixes said first low-pass filter output signal with said first LO signal to generate a first cancellation signal component;

11. The apparatus of claim 10 wherein said cancellation signal generator further comprises:
a third mixer that mixes said cancellation circuit input signal with a second LO signal having a phase that is an odd multiple of 90 degrees out of phase with said first LO signal to generate a third mixer output signal;
a second low-pass filter that filters said third mixer output signal to generate a second low-pass filter output signal in which frequency components of said third mixer output signal having frequencies above said first cutoff frequency are substantially attenuated;
a fourth mixer that mixes said second low-pass filter output signal with said second LO signal to generate a second cancellation signal component;
a combining circuit that combines said first cancellation signal component and said second cancellation signal component to generate said cancellation signal.

12. A method for reducing the amplitude of an input signal component characterized by an amplitude A_{b}, frequency f_{b} and a phase, P, in a signal comprising a plurality of input signal components including a component at a frequency f_{g} having an amplitude A_{g}, f_{b} being different from f_{b} said method comprising:
generating a cancellation signal having a frequency of f_{b} and an amplitude and phase determined by A and P by filtering a signal having a frequency component at f_{b}; and
combining said cancellation signal with said input signal to generate an output signal having an amplitude less than A′_{b} at f_{b} and A′_{g} at f_{g}, wherein A′_{b}/A_{b} is less than A′_{g}/A_{g}.

13. The method of claim 12 wherein generating said cancellation signal comprises filtering said input signal.

14. The method of claim 12 wherein generating said cancellation signal comprises amplifying and filtering said output signal.

15. The method of claim 12 wherein A′b/A_{b} is less than 0.01 times A′g/A_{g}.

16. The method of claim 12 wherein said filtering comprises:
down converting said input signal by a frequency difference determined by f_{b} to form a first IF signal;
filtering said IF signal to form a filtered IF signal, said filtering removing frequency components outside a band of frequencies that includes a signal down converted from said signal component at f_{b}, and said filtering passing signals that were down converted from said signal component at f_{b}; and
up converting said filtered IF signal by said frequency difference.

17. The method of claim 12 wherein said filtering of said IF signal comprises filtering said IF signal through a low-pass filter.

18. A band blocking filter comprising first and second stages, each stage comprising:
an input port that receives an input signal having a plurality of frequency components including a first frequency component at a frequency of f_{b} characterized by an amplitude, A, and phase and a second frequency component having a frequency of f_{g};
a cancellation signal generator that generates a cancellation signal having a frequency of f_{b} and an amplitude and phase determined by said first frequency component; and
a combining circuit having a signal input that receives said input signal and a cancellation signal input that receives said cancellation signal, said combining circuit combining said cancellation signal with said input signal to generate an output signal on a combining circuit output line, said output signal having said second frequency component and a residual signal at frequency f_{b} having an amplitude less than A,
wherein said input port of said second stage receiving said output signal from said subtractor circuit in said first stage.

19. The band blocking filter of claim 18 wherein said cancellation generator in said first stage comprises a first band pass filter having a first pass band that includes f_{b} and said cancellation generator in said second stage comprises a second band pass filter having a second pass band that includes f_{b}, said second pass band being greater than said first pass band.
